(19) United States
(12) Patent Application Publication
(10) Pub. No.: US 2012/0002718 A1
(43) Pub. Date: Jan. 5, 2012

(54) METHOD AND APPARATUS FOR SELECTING VIDEO CODEC TO BE USED BETWEEN STATIONS

(75) Inventors: Hae-young JUN, Seoul (KR); Sung-bum PARK, Seongnam-si (KR); Dong-seek PARK, Suwon-si (KR)

(73) Assignee: SAMSUNG ELECTRONICS CO., LTD., Suwon-si (JP)

(21) Appl. No.: 13/175,089

(22) Filed: Jul. 1, 2011

Related U.S. Application Data
(60) Provisional application No. 61/388,800, filed on Oct. 1, 2010.
(60) Provisional application No. 61/360,594, filed on Jul. 1, 2010.

(30) Foreign Application Priority Data
Jun. 13, 2011 (KR) 10-2011-0056999

(51) Int. Cl. H04N 7/26

(52) U.S. Cl. 375/240.02; 375/E07.126

(57) ABSTRACT

Provided is a video codec selection method which includes transmitting, by a station management entity (SME) of a first station, a codec selection request primitive which requests approval of a use of at least one codec to be used for compression of at least one video stream to a protocol adaptation layer (PAL) of the first station, transmitting, by the PAL of the first station, a codec selection request frame which requests approval of the use of the at least one codec to a second station, and receiving, by the PAL of the first station, a codec selection response frame which indicates whether the use of the at least one codec is approved from the second station.

### CROSS-REFERENCE TO RELATED PATENT APPLICATION

This application claims the benefit of U.S. Provisional Patent Application Nos. 61/360,594, filed on Jul. 1, 2010, and 61/388,800, filed on Oct. 1, 2010, in the U.S. Patent and Trademark Office and Korean Patent Application No. 10-2011-056999, filed on Jun. 13, 2011, in the Korean Intellectual Property Office, the disclosures of which are incorporated herein in their entirety by reference.

### BACKGROUND OF THE INVENTION

1. Field

Aspects of the exemplary embodiments of the present disclosure relate to a method and apparatus for selecting a video codec to be used between stations.

2. Description of the Related Art

Methods of transmitting video contents between devices over a wireless network may include a method of transmitting video contents in a non-compressive manner and a method of transmitting video contents compressed by a codec.

When video contents are transmitted in a non-compressive manner, the video contents can be transmitted without any degradation in quality of the video contents. However, since non-compressive transmission takes a long time, it cannot be used when the video contents should be reproduced in real time or a bandwidth of a communication link between the devices is small.

As a result, for a small bandwidth communication link or real-time reproduction of video contents, the video contents are transmitted in a form compressed by a codec. In this case, however, a receiving side needs to be notified about the type of codec used for the compression of the video contents.

### SUMMARY

An aspect of the present disclosure provides a method and apparatus for selecting a video codec to be used between stations.

According to an aspect of the present disclosure, there is provided a video codec selection method including transmitting, by a station management entity (SME) of a first station, a codec selection request primitive requesting approval of the use of at least one codec to be used for compression of at least one video stream to a protocol adaptation layer (PAL) of the first station, transmitting, by the PAL of the first station, a codec selection request frame requesting approval of the use of the at least one codec to a second station, and receiving, by the PAL of the first station, a codec selection response frame indicating whether the use of the at least one codec is approved from the second station.

The codec selection request frame may include at least one of a transaction identifier (ID) field identifying a process executed using the codec selection request frame, a stream number field indicating the number of video streams to which the at least one codec is to be applied, at least one stream ID field identifying at least one video stream to which the at least one codec is to be applied, and at least one codec ID fields identifying the at least one codec to be used for the compression, and the codec selection response frame may include at least one of a transaction ID field identifying a process executed using the codec selection response frame, a stream number field indicating the number of video streams to which the at least one codec is to be applied, at least one stream ID field identifying at least one video stream to which the at least one codec is to be applied, at least one result field indicating whether the use of the at least one codec is approved, and a rejection reason field indicating reasons for rejection of the use of the at least one codec.

The codec selection request primitive may include at least one of a peer station address indicating an address of a station which is to receive the codec selection request frame, at least one stream ID identifying at least one video stream to which the at least one codec is to be applied, and at least one codec ID identifying the at least one codec to be used for the compression.

The method may further include, upon receiving, by the first station, the codec selection response frame, transmitting, by the PAL of the first station, a codec selection confirm primitive for reporting a result of whether the use of the at least one codec is approved to the SME of the first station.

The codec selection confirm primitive may include at least one of at least one stream ID identifying at least one video stream to which the at least one codec is to be applied and at least one result information indicating whether the use of the at least one codec is approved.

The codec selection request frame may be transmitted during a channel time available in a medium access control (MAC) layer of the first station.

The method may further include upon receiving, by the second station, the codec selection request frame, transmitting, by a PAL of the second station, a codec selection indicate primitive for notifying reception of the codec selection request frame to the SME of the second station, and transmitting, by the SME of the second station, a codec selection response primitive indicating whether the use of the at least one codec is approved to the PAL of the second station.

The codec selection indicate primitive may include at least one of a peer station address indicating an address of a station which transmits the codec selection request frame, at least one stream ID identifying at least one video stream to which the at least one codec is to be applied, and at least one codec ID identifying the at least one codec to be used for the compression, and the codec selection response primitive may include at least one of a peer station address indicating an address of a station which transmits the codec selection request frame, at least one stream ID identifying at least one video stream to which the at least one codec is to be applied, and at least one result information indicating whether the use of the at least one codec is approved.

According to another aspect of the present disclosure, there is provided a station including a station management entity (SME) for generating a codec selection request primitive requesting approval of the use of at least one codec to be used for compression of at least one video stream and a protocol adaptation layer (PAL) for receiving the codec selection request primitive from the SME and transmitting a codec selection request frame requesting approval of the use of the at least one codec to a peer station, in which the PAL receives a codec selection response frame indicating whether the use of the at least one codec is approved from the peer station.

According to another aspect of the present disclosure, there is provided a computer-readable recording medium having recorded thereon a program for executing a video codec selection method which includes transmitting, by a station management entity (SME) of a first station, a codec selection request primitive requesting approval of the use of at least one codec to be used for compression of at least one video stream to a protocol adaptation layer (PAL) of the first station, transmitting, by the PAL of the first station, a codec selection request frame requesting approval of the use of the at least one codec to a second station, and receiving, by the PAL of the first station, a codec selection response frame indicating whether the use of the at least one codec is approved from the second station.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a flowchart illustrating a method of selecting a video codec according to an exemplary embodiment;

FIG. 2 is a diagram for describing a method of selecting a video codec according to another exemplary embodiment;

FIG. 3 is a diagram for describing a layer structure based on a Wireless Gigabit Alliance (WGA) layer management model;

FIG. 4 is a diagram showing a codec selection request frame according to an exemplary embodiment; and

FIG. 5 is a diagram showing a codec selection response frame according to an exemplary embodiment.

### DETAILED DESCRIPTION OF THE EXEMPLARY EMBODIMENTS

Hereinafter, exemplary embodiments of the present disclosure will be described in detail with reference to the accompanying drawings. However, the present disclosure is not restricted or limited to such exemplary embodiments. For reference, in explaining the present disclosure, well-known functions or constructions will not be described in detail so as to avoid obscuring the description with unnecessary detail. Expressions such as “at least one of,” when preceding a list of elements, modify the entire list and do not modify the individual elements of the list.

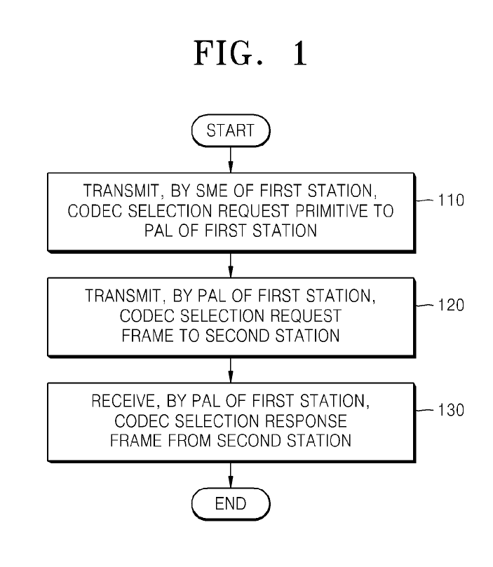

FIG. 1 is a flowchart illustrating a method of selecting a video codec according to an exemplary embodiment of the present disclosure.

In operation 110, a station management entity (SME) of a first station transmits a codec selection request message requesting approval of the use of at least one codec to be used for compression of at least one video stream to a protocol adaptation layer (PAL) of the first station.

The first station may further include a medium access control (MAC) layer.

Herein, a primitive refers to a command for information exchange between upper and lower layers. For example, the primitive may be classified into four types: REQUEST, INDICATE, RESPONSE, and CONFIRM. Most primitives related to data transmission are the REQUEST primitive transmitted from an upper layer to a lower layer and the INDICATE primitive transmitted from a lower layer to an upper layer. The CONFIRM primitive is intended to notify an upper layer about a responsibility to respond to a particular REQUEST primitive transmitted from the upper layer if a lower layer has such a responsibility. The RESPONSE primitive is intended to notify a lower layer about a responsibility to respond to a particular INDICATE primitive transmitted from the lower layer if an upper layer has such a responsibility.

In operation 120, the PAL of the first station transmits a codec selection request frame requesting approval of the use of the at least one codec to a second station.

The first station may transmit a codec selection request frame to the second station during a channel time available in a MAC layer of the first station.

Herein, the first station may be a device which transmits a video stream, and the second device may be a device which receives the video stream.

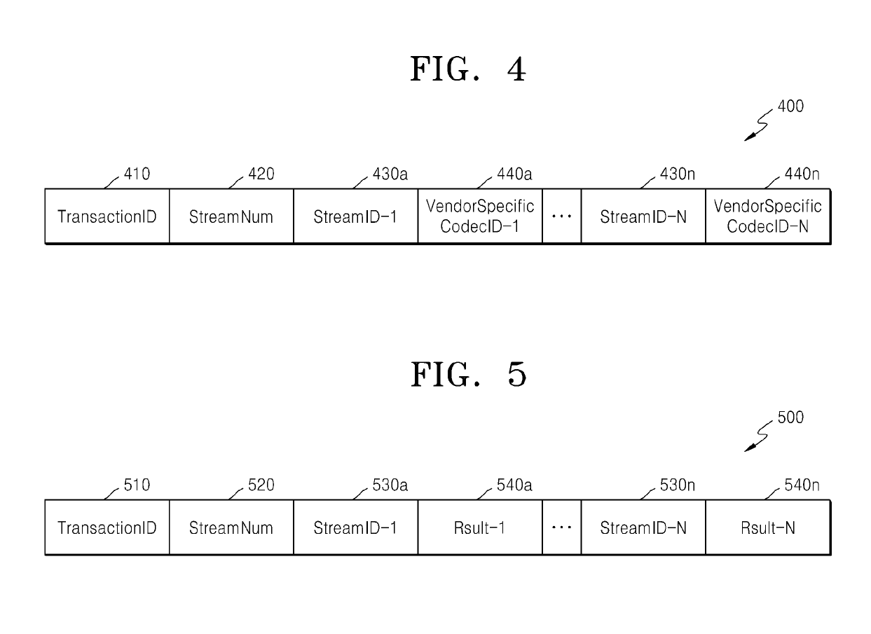

Meanwhile, a structure of the codec selection request frame according to an exemplary embodiment of the present disclosure will be described later with reference to FIG. 4.

In operation 130, the PAL of the first station receives a codec selection response frame indicating whether the use of the at least one codec is approved from the second station.

Once a video codec selection process between the first station and the second station is completed through operations 110 through 130, the first station transmits a compressed video stream to the second station by using the selected codec.

Meanwhile, a structure of the codec selection response frame according to an exemplary embodiment of the present disclosure will be described later with reference to FIG. 4.

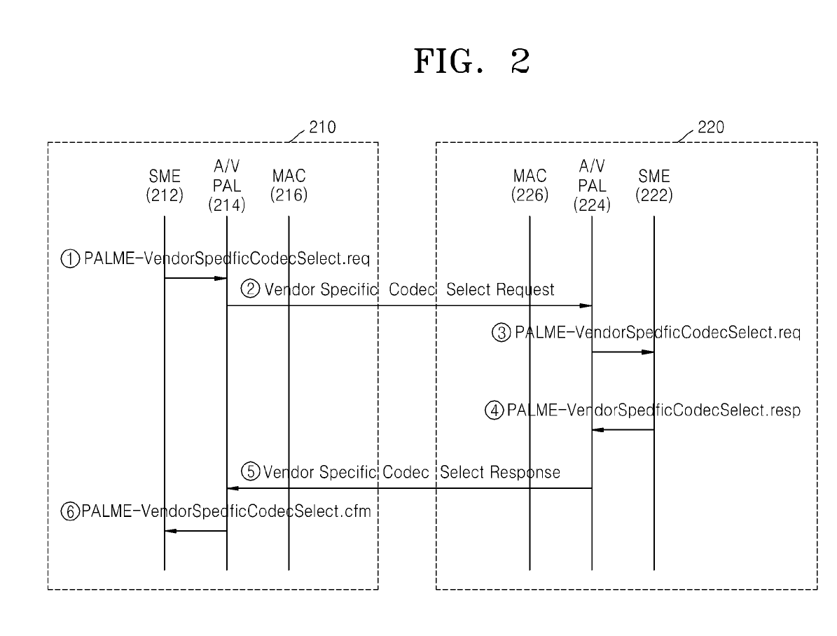

FIG. 2 is a diagram for describing a method of selecting a video codec according to another exemplary embodiment of the present disclosure.

Referring to FIG. 2, a video codec selection process performed between a first station 210 and a second station 220 is shown.

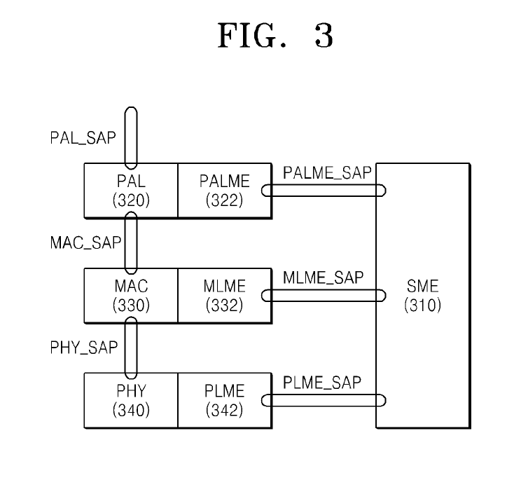

In FIG. 2, the first station 210 and the second station 220 include SMEs 212 and 222, audio/video (A/V) PALs 214 and 224, and MAC layers 216 and 226, respectively. The first station 210 may have a layer structure based on a Wireless Gigabit Alliance (WGA) layer management model of the IEEE standard 802.11, as will be described later with reference to FIG. 3.

In the first stage, the SME 212 of the first station 210 transmits “PALME-vendorSpecificCodecSelect.request”, which is a primitive requesting the second station 220 to select a codec provided by a particular vendor for each video stream, to the A/V PAL 214 of the first station 210.

A structure of the PALME-vendorSpecificCodecSelect.request primitive may be described as below.

```
PALME- VendorSpecificCodecSelect.request(
  Peer STA address
  StreamID
  VendorSpecificCodecID
)
```

That is, the PALME-VendorSpecificCodecSelect.request primitive includes “Peer STA address” indicating an address of a station which is to receive a codec selection request frame, “StreamID” indicating a stream identifier identifying a video stream to which a codec is to be applied, and “VendorSpecificCodecID” indicating an identifier of a codec provided by a vendor to be used for compression of the video stream.

In the second stage, the A/V PAL 214 of the first station 210 transmits a Vendor Specific Codec Select Request frame requesting the second station 220 to select a codec provided by a particular vendor for each video stream to the A/V PAL 224 of the second station 220.

The first station 210 transmits the Vendor Specific Codec Select Request frame during a channel time available in the MAC layer 216.

In the third stage, the A/V PAL 224 of the second station 220 transmits “PALME-VendorSpecificCodecSelect.indication”, which is a primitive for notifying reception of the Vendor Specific Codec Select Request frame, to the SME 222 of the second station 220.

A structure of the PALME-VendorSpecificCodecSelect.indication primitive may be described as below.

```
PALME- VendorSpecificCodecSelect.indication (
  Peer STA address
  StreamID
  VendorSpecificCodecID
)
```

That is, the PALME-VendorSpecificCodecSelect.indication primitive includes “Peer STA address” indicating an address of a station which transmits Vendor Specific Codec Select Request, “StreamID” indicating a stream identifier identifying a video stream to which a codec is to be applied, and “VendorSpecificCodecID” indicating an identifier of a codec provided by a vendor to be used for compression of the video stream.

In the fourth stage, the SME 222 of the second station 220 transmits “PALME-VendorSpecificCodecSelect.response”, which is a primitive indicating whether the use of a codec is approved, to the A/V PAL 224 of the second station 220.

A structure of the PALME-VendorSpecificCodecSelect.response primitive may be described as below.

```
PALME- VendorSpecificCodecSelect.response (
  Peer STA address
  StreamID
  ResultCode
)
```

That is, the PALME-VendorSpecificCodecSelect.response primitive includes “Peer STA address” indicating an address of a station which transmits Vendor Specific Codec Select Request, “StreamID” indicating a stream identifier identifying a video stream to which a codec is to be applied, and “ResultCode” indicating whether the use of the codec is approved.

In the fifth stage, the A/V PAL 224 of the second station 220 transmits a Vendor Specific Codec Select Response frame indicating whether the use of a codec is approved to the A/V PAL 214 of the first station 210.

The second station 220 transmits the Vendor Specific Codec Select Response frame during a channel time available in the MAC layer 226.

In the sixth stage, the A/V PAL 214 of the first station 210 transmits “PALME-VendorSpecificCodecSelect.confirmation”, which is a primitive for reporting a result of whether the use of a codec is approved, to the SME 212 of the first station 210.

A structure of the PALME-VendorSpecificCodecSelect.confirmation primitive may be described as below.

```
PALME- VendorSpecificCodecSelect.confirmation (
  StreamID
  ResultCode
)
```

That is, the PALME-VendorSpecificCodecSelect.confirmation primitive includes “StreamID” indicating a stream identifier identifying a video stream to which a codec is to be applied, and “ResultCode” indicating whether the use of the codec is approved.

The first station 210 and the second station 220 according to an exemplary embodiment of the present disclosure each may include a transmitting unit (not shown) and a receiving unit (not shown) for transmitting and receiving various types of frames, and includes at least some hardware (e.g., a transmitter or a receiver).

FIG. 3 is a diagram for describing a layer structure based on a WGA layer management model.

In FIG. 3, an SME 310 is an entity independent of other layers 320, 330, and 340, and collects layer-dependent information, sets a layer-dependent state for a particular layer, and requests execution of a particular operation in a particular layer. As previously mentioned, in the present disclosure, the SME 310 may generate a codec selection request primitive and transmit the same to a PAL 320.

The PAL 320 generates and transmits a codec selection request frame and receives a codec selection response frame. The PAL 320 may transmit the codec selection request frame to a peer station and receive the codec selection response frame from the peer station, through a MAC layer 330 and a PHY layer 340.

A PALME 322, an MLME 332, and a PLME 342 are entities for managing the PAL 320, the MAC layer 330, and the PHY layer 340, respectively.

A PAL_Service Access Point (SAP) serves as a passage connecting the PAL 320 with other layers, a MAC_SAP serves as a passage connecting the MAC layer 330 with the PAL 320, and a PHY_SAP serves as a passage connecting the PHY layer 340 with the MAC layer 330.

A PALME_SAP serves as a passage connecting the PALME 322 with the SME 310, an MLME_SAP serves as a passage connecting the MLME 332 with the SME 310, and a PLME_SAP serves as a passage connecting the PLME 342 with the SME 310.

Meanwhile, a more detailed description of components shown in FIG. 3 is provided in the IEEE standard 802.11 and thus will not be provided herein.

FIG. 4 is a diagram showing a codec selection request frame 400 according to an exemplary embodiment of the present disclosure.

Referring to FIG. 4, the codec selection request frame 400 according to an exemplary embodiment of the present disclosure includes a transaction ID field 410, a stream number field 420, stream ID fields 430a through 430n, and vendor ID fields 440a through 440n.

The transaction ID field 410 is a field identifying a process executed using the codec selection request frame 400, such that the transaction ID field 410 indicates that the codec selection request frame 400 is a frame requesting selection of a codec to be applied to a video stream.

The stream number field 420 indicates the number of video streams to which a codec is applied.

The stream ID fields 430a through 430n indicate IDs of video streams to which a codec is to be applied.

The vendor ID fields 440a through 440n indicate IDs of codecs provided by a vendor to be used for compression of video streams. In FIG. 4, N vendor codec ID fields 440a through 440n corresponding to N codecs are shown, and they may include IDs of N different types of codecs, respectively. For example, vendor ID field 440a indicates the ID of a codec associated with a video stream identified by stream ID field 430a, and so on.

FIG. 5 is a diagram showing a codec selection response frame 500 according to an exemplary embodiment of the present disclosure.

Referring to FIG. 5, the codec selection response frame 500 according to an exemplary embodiment of the present disclosure may include a transaction ID field 510, a stream number field 520, stream ID fields 530a through 530n, and result fields 540a through 540n.

The transaction ID field 510 is a field identifying a process executed using the codec selection response frame 500, such that the transaction ID field 510 indicates that the codec selection response frame 500 is a frame for indicating whether the use of a codec is approved.

The stream number field 520 indicates the number of video streams to which a codec is applied.

The stream ID fields 530a through 530n indicate IDs of video streams to which a codec is to be applied.

The result fields 540a through 540n indicate approval information indicating whether the use of codecs included in the codec selection request frame 400 is approved. Some of the result fields 540a through 540n may be information indicating approval of the use of the codecs included in the codec selection request frame 400 or some others may be information indicating rejection of the use of the codecs included in the codec selection request frame 400. For example, result field 540a indicates whether or not the use of the codec associated with a video stream identified by stream ID field 530a is approved.

In another exemplary embodiment, the codec selection response frame 500 may further include rejection reason fields (not shown) indicating reasons for rejection of the use of the codecs included in the codec selection request frame 400.

Meanwhile, the exemplary embodiments of the present disclosure can be embodied as a program on recording media that can be implemented on computers and embedded devices and can be implemented in general-purpose digital computers that execute the program using the recording media. Examples of the recording media include magnetic storage media such as read-only memory (ROM), floppy disks, and hard disks, and optical data storage devices such as CD-ROMs and digital versatile discs (DVD).

While the present invention has been particularly shown and described with reference to exemplary embodiments thereof, it will be understood by one of ordinary skill in the art that various changes in form and detail may be made therein without departing from the spirit and scope of the present invention as defined by the following claims. Accordingly, the disclosed exemplary embodiments should be considered in a descriptive sense and not in a restrictive sense. The scope of the present invention will be defined by the appended claims, and differences in scope equivalent to the appended claims should be construed as being included in the present invention.

What is claimed is:

1. A method of selecting a video codec, the method comprising:
transmitting, by a station management entity (SME) of a first station, a codec selection request primitive which requests approval of a use of at least one codec to be used for compression of at least one video stream to a protocol adaptation layer (PAL) of the first station;
transmitting, by the PAL of the first station, a codec selection request frame which requests approval of the use of the at least one codec to a second station; and
receiving, by the PAL of the first station, a codec selection response frame which indicates whether the use of the at least one codec is approved from the second station.

2. The video codec selection method of claim 1, wherein the codec selection request frame comprises at least one of a transaction identifier (ID) field which identifies a process executed using the codec selection request frame, a stream number field which indicates a number of video streams to which the at least one codec is to be applied, at least one stream ID field which identifies the at least one video stream to which the at least one codec is to be applied, and at least one codec ID field which identifies the at least one codec to be used for the compression, and
the codec selection response frame comprises at least one of a transaction ID field which identifies a process executed using the codec selection response frame, the stream number field which indicates the number of video streams to which the at least one codec is to be applied, the at least one stream ID field which identifies the at least one video stream to which the at least one codec is to be applied, at least one result field which indicates whether the use of the at least one codec is approved, and a rejection reason field which, if the use is rejected, indicates reasons for rejection of the use of the at least one codec.

3. The video codec selection method of claim 1, wherein the codec selection request primitive comprises at least one of a peer station address which indicates an address of a station which is to receive the codec selection request frame, at least one stream identifier (ID) which identifies the at least one video stream to which the at least one codec is to be applied, and at least one codec ID which identifies the at least one codec to be used for the compression.

4. The video codec selection method of claim 1, further comprising, upon receiving by the first station the codec selection response frame, transmitting, by the PAL of the first station to the SME of the first station, a codec selection confirm primitive which reports a result of whether the use of the at least one codec is approved.

5. The video codec selection method of claim 4, wherein the codec selection confirm primitive comprises at least one of at least one stream identifier (ID) which identifies the at least one video stream to which the at least one codec is to be applied, and at least one result information which indicates whether the use of the at least one codec is approved.

6. The video codec selection method of claim 1, wherein the codec selection request frame is transmitted during a channel time available in a medium access control (MAC) layer of the first station.

7. The video codec selection method of claim 1, further comprising:
upon receiving by the second station the codec selection request frame, transmitting, by a PAL of the second station to the SME of the second station, a codec selection indicate primitive which notifies reception of the codec selection request frame; and
transmitting, by the SME of the second station to the PAL of the second station, a codec selection response primitive which indicates whether the use of the at least one codec is approved.

8. The video codec selection method of claim 7, wherein the codec selection indicate primitive comprises at least one of a peer station address which indicates an address of a station which transmits the codec selection request frame, at least one stream identifier (ID) which identifies the at least one video stream to which the at least one codec is to be applied, and at least one codec ID which identifies the at least one codec to be used for the compression, and
the codec selection response primitive comprises at least one of the peer station address which indicates the address of the station which transmits the codec selection request frame, the at least one stream ID which identifies the at least one video stream to which the at least one codec is to be applied, and at least one result information which indicates whether the use of the at least one codec is approved.

9. A station comprising:
a station management entity (SME) which generates a codec selection request primitive which requests approval of a use of at least one codec to be used for compression of at least one video stream; and
a protocol adaptation layer (PAL) which receives the codec selection request primitive from the SME and transmits a codec selection request frame which requests approval of the use of the at least one codec to a peer station,
wherein the PAL which receives a codec selection response frame which indicates whether the use of the at least one codec is approved from the peer station.

10. The station of claim 9, wherein the codec selection request frame comprises at least one of a transaction identifier (ID) field which identifies a process executed using the codec selection request frame, a stream number field which identifies a number of video streams to which the at least one codec is to be applied, at least one stream ID field which identifies the at least one video stream to which the at least one codec is to be applied, and at least one codec ID field which identifies the at least one codec to be used for the compression, and
the codec selection response frame comprises at least one of a transaction ID field which identifies a process executed using the codec selection response frame, the stream number field which indicates the number of video streams to which the at least one codec is to be applied, the at least one stream ID field which identifies the at least one video stream to which the at least one codec is to be applied, at least one result field which indicates whether the use of the at least one codec is approved, and a rejection reason field which, if the use is rejected, indicates reasons for rejection of the use of the at least one codec.

11. The station of claim 9, wherein the codec selection request primitive comprises at least one of a peer station address which indicates an address of a station which is to receive the codec selection request frame, at least one stream identifier (ID) which identifies the at least one video stream to which the at least one codec is to be applied, and at least one codec ID which identifies the at least one codec to be used for the compression.

12. The station of claim 9, wherein upon receiving the codec selection response frame, the PAL transmits a codec selection confirm primitive for reporting a result of whether the use of the at least one codec is approved to the SME of the first station.

13. The station of claim 12, wherein the codec selection confirm primitive comprises at least one of at least one stream identifier (ID) which identifies the at least one video stream to which the at least one codec is to be applied, and at least one result information which indicates whether the use of the at least one codec is approved.

14. The station of claim 9, further comprising a medium access control (MAC) layer, wherein the codec selection request frame is transmitted during a channel time available in the MAC layer.

15. The station of claim 9, wherein the peer station comprises:
a second PAL which receives the codec selection request frame and generates a codec selection indicate primitive which notifies reception of the codec selection request frame; and
a second SME which receives the codec selection indicate primitive from the second PAL and transmits a codec selection response primitive which indicates whether the use of the at least one codec is approved to the second PAL.

16. The station of claim 15, wherein the codec selection indicate primitive comprises at least one of a peer station address which indicates an address of a station which transmits the codec selection request frame, at least one stream identifier (ID) which identifies the at least one video stream to which the at least one codec is to be applied, and at least one codec ID which identifies the at least one codec to be used for the compression, and
the codec selection response primitive comprises at least one of the peer station address which indicates the address of the station which transmits the codec selection request frame, the at least one stream ID which identifies the at least one video stream to which the at least one codec is to be applied, and at least one result information which indicates whether the use of the at least one codec is approved.

17. A computer-readable recording medium having recorded thereon a program for executing a video codec selection method, the method comprising:
transmitting, by a station management entity (SME) of a first station, a codec selection request primitive which requests approval of a use of at least one codec to be used for compression of at least one video stream to a protocol adaptation layer (PAL) of the first station;
transmitting, by the PAL of the first station, a codec selection request frame which requests approval of the use of the at least one codec to a second station; and
receiving, by the PAL of the first station, a codec selection response frame which indicates whether the use of the at least one codec is approved from the second station.
